(19) United States
(12) Patent Application Publication
(10) Pub. No.: US 2005/0064745 A1
(43) Pub. Date: Mar. 24, 2005

(54) Terminal for electrical connector

(76) Inventor: Chi Zhang, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/949,997

(22) Filed: Sep. 23, 2004

(30) Foreign Application Priority Data
Sep. 23, 2003 (CN) 03278773.1

(51) Int. Cl. H01R 12/00

(52) U.S. Cl. 439/83

(57) ABSTRACT

A terminal (1) for an electrical connector includes a flat soldering portion (11), a flexed portion (12) extending from the soldering portion, and a contacting portion (14) extending upwardly from the flexed portion. The soldering portion has a soldering face (111) and the connecting portion extends away from the soldering face. A rectangular overflowing aperture (120) extends through a centre of the flexed portion. Thus, the terminal is securely soldered on a printed circuit board to thereby achieve a reliable electrical connection between the terminal and the printed circuit board.

### BACKGROUND OF THE INVENTION

1. Field of the Invention

The present invention generally relates to a terminal for an electrical connector, and more particularly to a terminal having good soldering quality.

2. Description of Related Art

In the electronic industry, an electrical connector is usually mounted on a printed circuit board (PCB) with a tail portion of the terminal connecting with a corresponding trace of the PCB. Generally, the tail portion of the terminal can be inserted into a corresponding through hole of the PCB for building an electrical connection between the electrical connector and the PCB, the method of which is referred as “Through Hole Technology” (THT). Also, the tail portion can extend parallel to the PCB and be soldered on an electrical pad disposed on a surface of the PCB, the method of which is referred as “Surface Mount Technology” (SMT).

The trend to reduce the size of the electronic equipment, has resulted in an ongoing drive for miniaturization and multi-layer of the PCB. Because the THT requires a plurality of through holes in the PCB for receiving the tail portions of the terminals of the electrical connector, the valuable space of the PCB will be occupied and the arrangement of the trace on the PCB will be effected. Comparing with the THT, the SMT terminals can be soldered on the surface of the PCB directly and will not affect the interior structure of the PCB thereby making full use of the conductive trace arranged on the PCB.

During soldering process, the flat tail portions of the SMT terminals are usually positioned and aligned with the corresponding electrical pads of the PCB, to which a layer of the solder paste has been applied in advance. The SMT terminals and the PCB are then heated to a predetermined temperature at which the solder paste melts and fuses so as to solder the terminals on the electrical pads. Referring to FIG. 4, a conventional terminal 5 for an electrical connector comprises a mating portion 51, a retention portion 52 extending from the mating portion 51, a connecting portion 53 extending downwardly from the retention portion 52 and a flat soldering portion 54 bent transversely from the connecting portion 53 for being soldered on the PCB. However, a rectangular bottom face of the soldering portion 54 has poor effect of holding soldering tin and the connecting area between the soldering portion and the connecting portion has a smooth, continuous surface. Thus, the solder paste can only cover the rectangular soldering portion, which will effect the soldering quality and further effect the reliable electrical connection between the electrical connector and the PCB.

Hence, a terminal for an electrical connector having good soldering effect is required to overcome the disadvantages of the related art.

### SUMMARY OF THE INVENTION

An object of the present invention is to provide a terminal for an electrical connector having a tail portion which has good soldering effect and can be connected to a PCB reliably.

In order to achieve the object set forth, a terminal for an electrical connector in accordance with the present invention comprises a flat soldering portion, a flexed portion extending from the soldering portion, and a contacting portion extending upwardly from the flexed portion. The soldering portion has a soldering face and the connecting portion extends away from the soldering face. A rectangular overflowing aperture extends through a centre of the flexed portion.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a cross-sectional view of a terminal in accordance with the present invention, showing the terminal being soldered on a PCB;

FIG. 2 is a perspective view of the terminal;

FIG. 3 is a perspective view of a terminal in accordance with another embodiment of the present invention; and

FIG. 4 is a perspective view of a conventional terminal for an electrical connector.

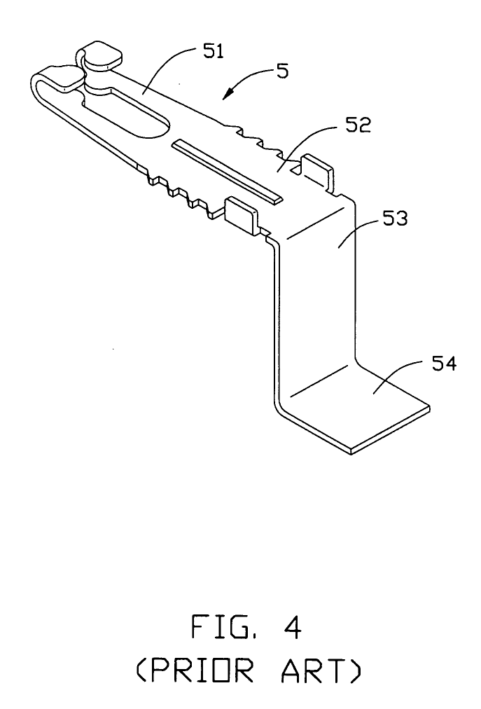

### DETAILED DESCRIPTION OF THE INVENTION

Reference will now be made in detail to the preferred embodiment of the present invention.

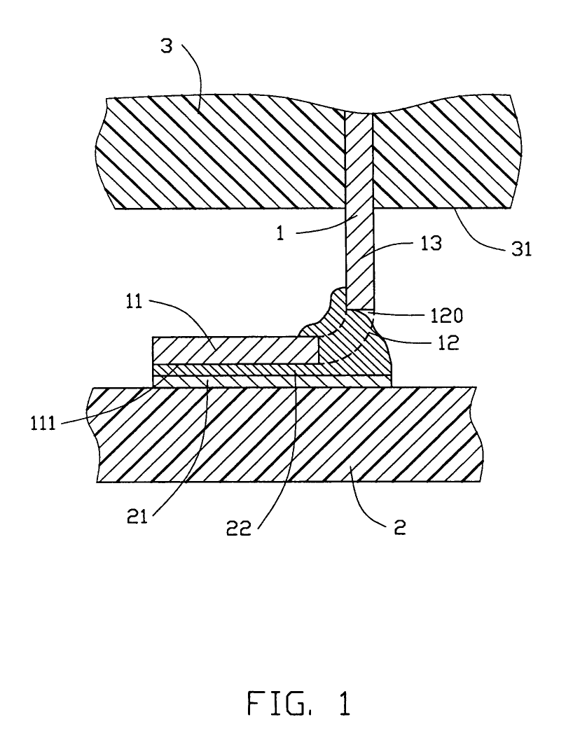

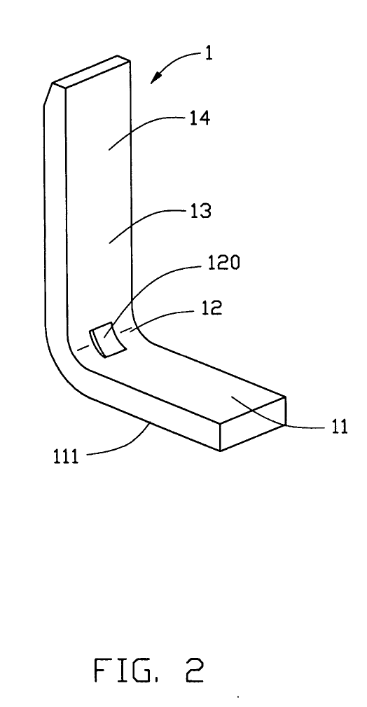

Referring to FIGS. 1-2, a terminal 1 in accordance with the present invention comprises a flat soldering portion 11, a flexed portion 12 connecting with an end of the soldering portion 11, a connecting portion 13 extending upwardly from the flexed portion 12 and a contacting portion 14 further extending upwardly from the connecting portion 13 for mating with a complementary connector (not shown). The soldering portion 11 has a soldering face 111 and the connecting portion 13 extends away from the soldering face 111. A rectangular overflowing aperture 120 is defined through a center of the flexed portion 12.

The contacting portion 14 of the terminal 1 is received in an insulative housing 3 of an electrical connector. The connecting portion 13 extends downwardly out of a bottom face 31 of the insulative housing 3. The flexed portion 12 is formed with an arc, with a smooth surface. The soldering portion 11 extends from the flexed portion 12 and parallel to the bottom face 31 of the insulative housing 3. A printed circuit board 2 is positioned parallel to the bottom face 31 and has a number of conductive pads 21 thereon. A layer of the solder paste 22 is applied on the pads 21 in advance.

During soldering process, the terminals 1 and the PCB 2 are heated to a predetermined temperature at which the melted solder paste 22 fills the space between the pad 21 and the soldering face 111 of the soldering portion 11. Further, a part of melted tin extends through the overflowing aperture 120 and covers part area of the arcuate surface of the flexed portion 12, the soldering portion 11 and the connecting portion 13. Thus, the tail portion of the terminal 1 is substantially securely soldered on the PCB 2 to thereby secure a reliable electrical connection between the terminal 1 and the PCB 2.

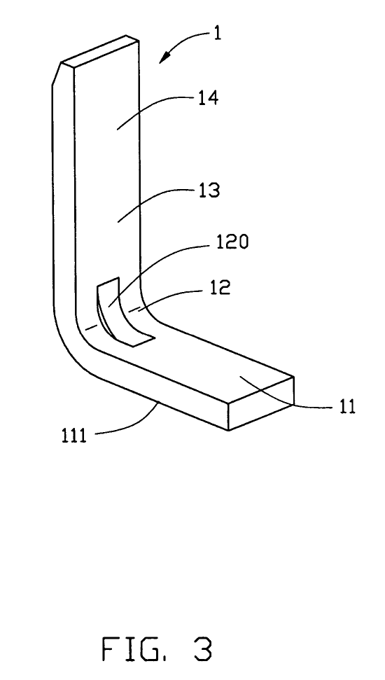

Referring to FIG. 3, it discloses a terminal 1 in accordance with another embodiment of the present invention. Comparing with FIG. 2, the difference is that the overflowing aperture 120 of the flexed portion 12 of FIG. 3 extends to the connecting portion 13 a predetermined distance, and/or extends to the soldering portion 11 a predetermined distance.

It should be noted that the overflowing aperture 120 may be disposed in the flexed portion 12 offset from the center. Certainly, the flexed portion 12 can also define a number of overflowing apertures 120 if the width of the terminal 1 is enough. Furthermore, the shape of the overflowing apertures 120 can also be round or other shape. These modifications can achieve the same effect as the preferred embodiment described above.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A terminal for an electrical connector adapted for surface mounting on a printed circuit board, comprising:
a soldering portion having a soldering face;
a connecting portion projecting perpendicularly to the soldering portion and extending away from the soldering face; and
a flexed portion connecting the soldering portion and the connecting portion and defining an overflowing aperture extending therethrough.

2. The terminal as claimed in claim 1, wherein the overflowing aperture is defined in a center of the flexed portion.

3. The terminal as claimed in claim 1, wherein the overflowing aperture extends to the soldering portion a predetermined distance.

4. The terminal as claimed in claim 1, wherein the overflowing aperture extends to the connecting portion a predetermined distance.

5. The terminal as claimed in claim 1, wherein the flexed portion has an arcuate surface.

6. A terminal assembly for an electrical connector adapted for surface mounting on a printed circuit board, comprising:
a soldering portion having a downward horizontal soldering face;
a connecting portion located above the soldering portion and extending upwardly away from the soldering face; and
a joined portion connecting the soldering portion and the connecting portion together to form a subassembly, and defining an overflowing aperture extending therethrough to communicates two sides of said subassembly with each other.

7. The terminal assembly as claimed in claim 6, wherein said apertures is filled with solder as well as the solder face.

8. The terminal assembly as claimed in claim 6, wherein the connecting portion is perpendicular to said soldering portion.

9. The terminal assembly as claimed in claim 6, wherein said aperture extends along the connection portion with a predetermined distance.

10. A connector assembly comprising:
a printed circuit board;
an insulative housing located above the printed circuit board;
a terminal including:
a soldering portion having a downward horizontal soldering face seated upon the printed circuit board;
a connecting portion located above the soldering portion and extending upwardly away from the soldering face into the housing; and
a joined portion connecting the soldering portion and the connecting portion together to form a subassembly, and defining an overflowing aperture extending therethrough to communicates two sides of said subassembly with each other; wherein
solder is filled in not only a space between the solder face and the printed circuit board, but also the aperture.
